(19) United States
(12) Patent Application Publication
(10) Pub. No.: US 2016/0109277 A1
(43) Pub. Date: Apr. 21, 2016

(54) OPTICALLY-BASED METHOD AND SYSTEM FOR MEASURING LIQUIDS IN TANKS

(71) Applicant: Elwin G. Hunt, Sandy, UT (US)

(72) Inventor: Elwin G. Hunt, Sandy, UT (US)

(21) Appl. No.: 14/517,715

(22) Filed: Oct. 17, 2014

(51) Int. Cl. G01F 22/00; G01S 17/88; G01F 23/00

(52) U.S. Cl. CPC G01F 22/00; G01F 23/0061; G01S 17/88

(57) ABSTRACT

A system and method for determining a liquid level in a storage tank includes the use of a laser range finding device. The laser range finding device emits a signal that is reflected off of a top surface of the liquid and then detected by a sensor. The time between the signal emission and detection is utilized to determine a distance to the surface of the liquid. This distance is then utilized to determine an amount of liquid in the tank. The liquid may comprise any liquid with sufficient reflectivity to reflect the signal from the range finding device. The system and method is particularly suited for determining the amount of milk in storage tanks associated with dairy operations.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Present Disclosure

The present disclosure relates generally to measuring devices, and more particularly, but not necessarily entirely, to measuring devices for measuring liquid levels inside storage tanks.

2. Description of Related Art

Dairy cattle operations may collect thousands of gallons of milk per day. The collected milk is stored in large stainless steel tanks onsite until the milk can be shipped to a milk processing plant. In particular, the milk may be loaded from the storage tanks onto milk hauling trucks. The milk hauling trucks may then transport the milk to the appropriate milk processing plant, where the milk is unloaded and processed.

Dairy cattle operators are typically paid based upon the volume or the weight of the milk received at the processing plant. Unfortunately, discrepancies between the dairy cattle operators and the processing plant regarding payment frequently arise. For example, a dairy cattle operator may believe that more milk was delivered to the processing plant than the amount acknowledged by the plant. While some fault may be attributed to the processing plants, often times the dairy cattle operators are simply relying on inaccurate tank measurements when determining the amount of milk delivered to the processing plants.

Currently the dairy industry uses weight scales, pressure gauges, sight tubes, and dipstick methods to measure milk. The weight scales consist of load cells (strain gauges) at the bottom of a milk storage tank at the mounting point to the ground or the weight scales that a milk hauling truck rolls over. By first measuring the weight of the system while empty and then subsequently measuring the weight with milk in the tank, the weight of the milk is determined by the simple calculation of (system weight with milk) minus (system weight empty) equals the weight of milk. The system is calibrated throughout the expected range of possible weights to be measured by the system.

Pressure gauges are used in measuring milk in tanks by mounting the pressure sensor near the bottom of the tank. These devices are similar to the weight scales in that they generally use the same strain gauge technology to measure pressure. However, they differ in that these devices only measure the pressure provided by the height of the level of the milk in the tank, not the total volume of milk as in the weight scales.

The sight tube method is comprised of a tube made of a transparent material that runs directly vertical along the side of the tank. This tube is attached to the bottom of the tank such that as the milk level in the tank moves up or down this level is also indicated in the tube. In parallel with the tube is a measuring rod or stick normally made of stainless steel or aluminum with ruler like markings on it. The user looks at the level of milk in the tube and visually aligns that with the nearest marking on the measuring rod. That reading is then located on a calibration chart to determine the volume of milk in the tank, which charts will often report weight using an industry standard of average milk density to convert the volume to weight.

The dipstick method is simply using a measuring stick and dipping it in the tank until it reaches the bottom and reading the height of the milk on the stick. Using a calibration table this measurement is then converted to volume or weight using the industry standard of milk density.

The above measurement methods, while helpful, are prone to inaccurate and costly results caused by a variety of factors, including human error, miscalibration, and mechanical failure. Further, even when accurate, the measurement methods described require costly manpower and/or maintenance to obtain real-time tank measurements.

The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of a liquid measurement system according to an embodiment of the present disclosure;

FIG. 2 is a diagram of a liquid measurement device according to an embodiment of the present disclosure;

FIG. 3 is a diagram of a liquid measurement system according to an embodiment of the present disclosure;

FIG. 4 is a diagram of a centralized liquid management system according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” and grammatical equivalents thereof are inclusive or open-ended terms that do not exclude additional, unrecited elements or method steps.

Applicant has discovered a novel system and method for measuring levels of liquids in storage tanks. In an embodiment, the system and method may comprise an electronic range finder positioned to determine a liquid level in the storage tank. The electronic range finder may determine a distance between it and a top surface of the liquid. The electronic range finder may report the distance to a processor-based computing device. The device may then compute the amount of liquid in the tank, either by volume, weight, or both, based upon the distance. In an embodiment, the electronic range finder may be an optical range finder that emits light. For example, the electronic range finder may be a laser range finder.

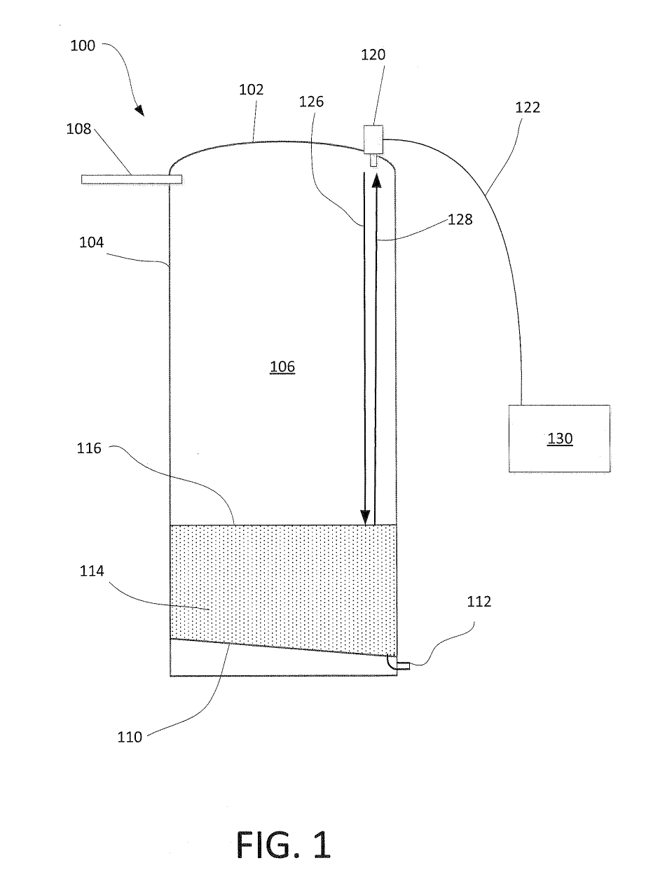

Referring now to FIG. 1, there is shown a liquid measurement system 100 according to an embodiment of the present disclosure. The system 100 may comprise a liquid storage tank 102. In an embodiment, the storage tank 102 may be formed from stainless steel according to health and safety standards established either by industry standards or governmental standards or some other standards.

In an embodiment, the tank 102 may comprise a sidewall 104 that defines a storage reservoir 106 within the interior of the tank 102. The tank may further comprise an inlet 108 for filling the tank 102 with a liquid. The tank 102 may further comprise a sloped bottom 110 that leads to a drain 112 in order to allow the tank 102 to be emptied. In an embodiment, the tank 102 may have a cooling system (not shown) in order to cool the liquid primarily to prevent the growth of micro-organisms.

The tank 102 may have a liquid storage capacity defined by the size of the storage reservoir 106. In an embodiment, the storage capacity of the tank 102 may be in the range from 50 gallons to 2000 gallons. In an embodiment, the storage capacity of the tank 102 is greater than 2000 gallons. It will be appreciated that the present invention can be utilized with almost any size storage tank.

As mentioned, a liquid 114 may be directed into the tank 102 through the inlet 108. The liquid 114 may have a top surface 116. In an embodiment, the liquid 114 may be milk collected from dairy cattle from milking machines as is known to one of ordinary skill. The milk may come from just a few cattle, but also from hundreds or thousands of cattle as is typical in large scale dairy operations. The tank 102 may be located relatively close to the milking site. In an embodiment, the tank 102 may be located at a milk processing plant or creamery. Thus, it will be appreciated that the tank 102 may be located at any location.

Coupled to the sidewall 104 of the tank 102 may be a range finding device 120. The range finding device 120 may include an emitter for emitting a signal within the tank 102. The range finding device 120 may further include a sensor for detecting a return or reflected signal. A processor within the range finding device 120 may calculate the time it took for the signal to travel to the target and back to the sensor. Using the calculated time, the range finding device 120 may determine distance data, which may or may not be a distance to the target.

In operation, the range finding device 120 is positioned to determine a distance to the top surface 116 of the liquid 114. In an embodiment, the range finding device 120 is mounted at the top of the tank 102 such that the signal it emits travels vertically downward to the top surface 116 of the liquid 114. That is, the direction of the signal may be perpendicular to the top surface 116 of the liquid 114. Arrows 126 and 128 shown in FIG. 1 indicate the path of the emitted signal and the reflected signal, respectively.

In an embodiment, the range finding device 120 emits signals in short bursts. In an embodiment, the range finding device 120 emits bursts of light. In an embodiment, the light may be visible light or non-visible light. In an embodiment, the range finding device 120 may emit a laser beam. In an embodiment, the range finding device 120 may emit short bursts of an energy beam. In an embodiment, the range finding device 120 may emit pulses of electromagnetic waves, such as radio waves.

It will be appreciated that the sensor of the range finding device is adapted to detect a return signal corresponding to the emitted signal. For example, the sensor may include a light sensor or an electromagnetic sensor. It will be appreciated that the range finding device 120 may utilize any type of emitted signal that is capable of reliably providing a return signal from the surface 116 of the liquid 114.

The range finding device 120 may continuously or intermittently determine a distance to the top surface 116 of the liquid 114. The range finding device 120 may report the distance through a communication link 122 to a control device 130. In an embodiment, the communication link 122 between the range finding device 120 and the control device 130 may comprise one of a wired path or a wireless path. In an embodiment, the range finding device 120 and the control device 130 may be integrated into a single unit that utilizes a common processing module.

The control device 130 may calculate the amount of the liquid 114 based upon the distance data reported by the range finding device 120. The control device 130 may then display or otherwise report the amount of liquid 114 in the tank 102. For example, the control device 130 may send an electronic message with the amount of liquid 114 in the tank 102 to an account of an pre-designated recipient. For example, the control device 130 may send an email, text, data feed or any other type of electronic message or notice reporting the amount of liquid 114 in the tank 102 to another electronic device, such as a computer, server or smart phone.

As mentioned, the control device 130 may calculate the amount of liquid 114 in the tank 102 using distance data determined by the range finding device 120. Prior to operation, the control device 130 may be calibrated in order to ensure that the reported amount of liquid 114 is accurate. In an embodiment, the amount of liquid 114 in the tank 102 is determined using a look-up table stored in a memory of the device 130. The look-up table may include distances with corresponding liquid amounts, either in volume or weight. In an embodiment, the control device 130 may calculate in real-time the amount of liquid 114 in the tank 102 based upon the geometry of the tank 102.

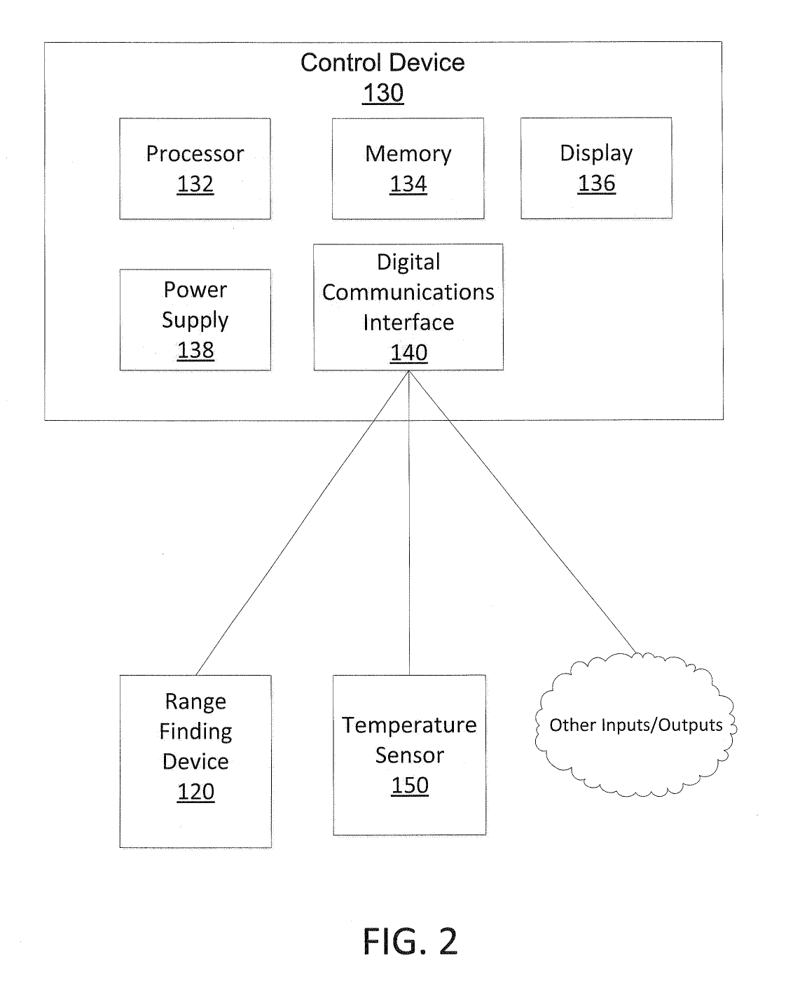

Referring now to FIG. 2, in an embodiment, the control device 130 may include a microprocessor 132. The microprocessor 132 may be operable to determine the amount of liquid 114 in the tank 102 using distance data reported by the range finding device 120. In this regard, the memory 134 may contain executable instructions, also known as code, that when executed by the microprocessor 132, causes the microprocessor 132 to determine the amount of liquid 114 in the tank 102. In an embodiment, the memory 134 may store a look-up table for determining the amount of liquid 114 in the tank 102 as described above. In an embodiment, the memory 134 may include an algorithm for determining the amount of liquid 114 in the tank 102 using the geometry of the tank 102. For example, the algorithm may utilize a volume formula adapted for the geometry of the tank 102.

It will be appreciated that the microprocessor 132 may be any suitable microprocessor, including, but not limited to, programmable microprocessors. The memory 134 may include any suitable electronic data storage device, including FLASH, RAM and ROM memory, and may be separate from, or built into, the microprocessor 132.

In an embodiment, the control device 130 may include a display 136. The display 136 may be a touchscreen or any other type of display suitable for displaying information. The display 136 may indicate to a user the amount of liquid 114 in the tank 102. In an embodiment, the control device 130 may include a power supply 138. In an embodiment, the control device 130 may be connected to a power grid. In an embodiment, the control device 130 may include a battery.

The control device 130 may further include a digital communications interface 140. The digital communications interface 140, usually an electronic circuit, is designed to a specific standard and enables the control device 130 to communicate with other devices. In an embodiment, the control device 130 receives signals containing distance data from the range finding device 120 through the digital communications interface 140. In an embodiment, the control device 130 receives signals containing temperature data from a temperature sensor 142 located within the tank 102 through the digital communications interface 140. In an embodiment, the control device 130 receives signals containing data from other sensors or devices.

In an embodiment, the control device 130 may be connected to a communications network, such as wide area networks or local area networks. The control device 130 may be connected to the communications network through a wired or wireless connection as known to those of ordinary skill. The control device 130 may report tank data regarding the amount of liquid 114 in the tank 102 over the communications network to designated recipients. For example, the tank data may report the temperature and amount of liquid 114 in the tank 102.

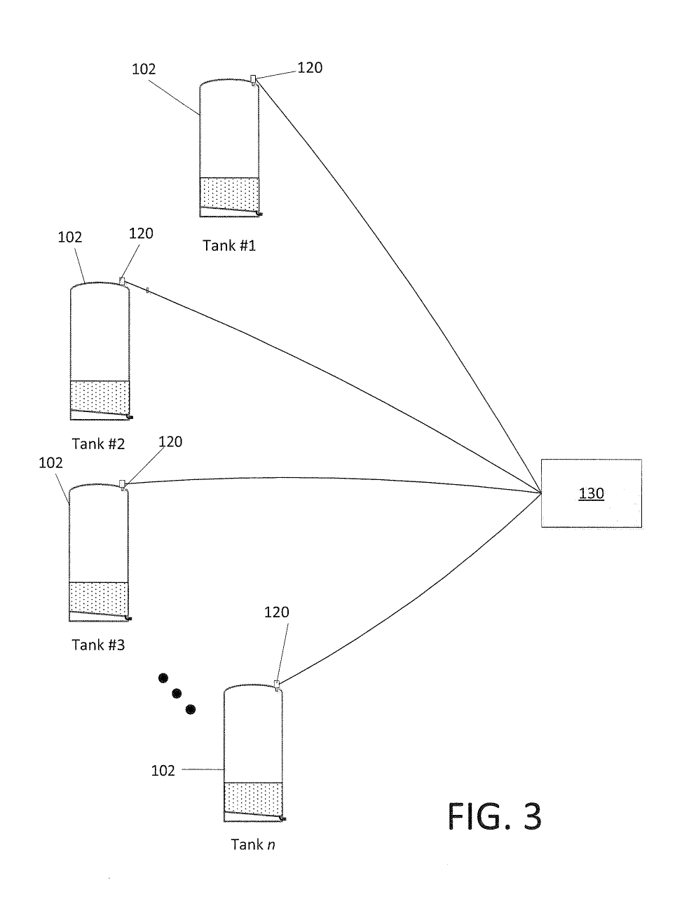

Referring now to FIG. 3, the system 100 shown in FIG. 1 may be scalable such that a single control device 130 monitors and reports tank levels in multiple tanks 102. Each tank 102 may include its own range finding device 120 that reports to the control device 130.

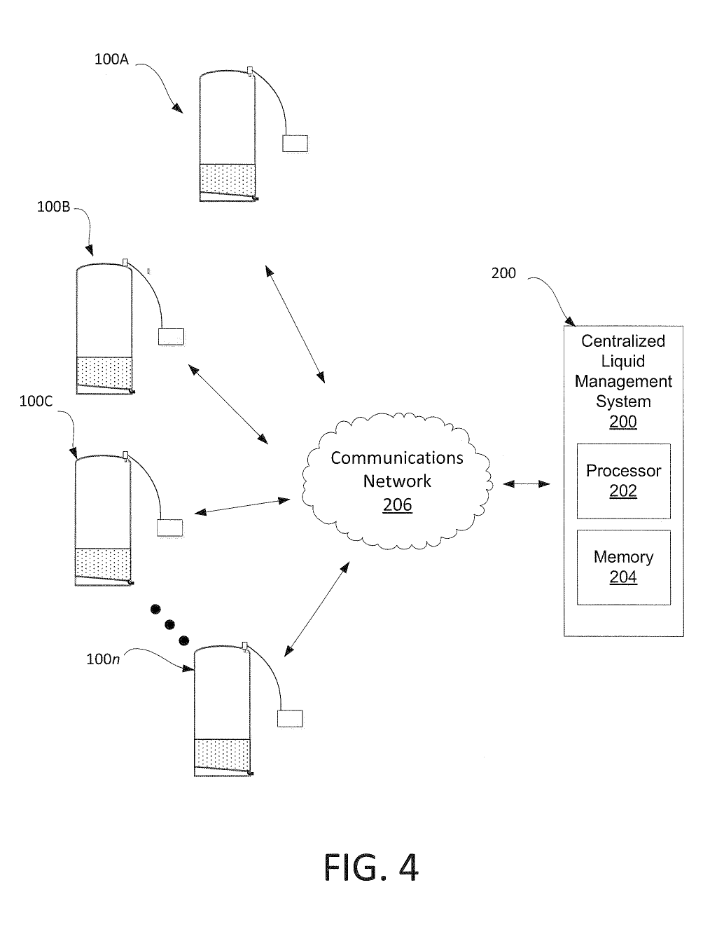

Referring now to FIG. 4, multiple systems 100A-100n, each similar to system 100 shown in FIG. 1, may electronically communicate over a network 206 with a centralized liquid management system 200. In particular, each of the systems 100A-100n may provide tank data to the centralized liquid management system 200. The centralized liquid management system 200 may utilize the tank data to determine pick-up schedules for a liquid hauler or otherwise monitor tank operation and production.

The centralized liquid management system 200 may include a processor 202 and memory 204 for performing the operations described herein. In particular, the processor 202 may receive the tank data from the systems 100A-100n over the network 206. The processor 202 may determine when the tank levels are full or almost full and schedule a pick-up from a liquid hauler.

It will be appreciated that the tank level information as determined by the present disclosure may be utilized to accurately determine the amount of liquid delivered to a milk processor. In this regard, the present invention may significantly reduce disputes between dairy operations and milk processors.

It will be appreciated that the structure and apparatus disclosed herein is merely one example of a means for determining a liquid level in a tank, and it should be appreciated that any structure, apparatus or system for determining a liquid level in a tank which performs functions the same as, or equivalent to, those disclosed herein are intended to fall within the scope of a means for determining a liquid level in a tank, including those structures, apparatus or systems for determining a liquid level in a tank which are presently known, or which may become available in the future. Anything which functions the same as, or equivalently to, a means for determining a liquid level in a tank falls within the scope of this element.

Those having ordinary skill in the relevant art will appreciate the advantages provide by the features of the present disclosure. For example, it is a feature of the present disclosure to provide a system for accurately determining a liquid level in a tank. Another feature of the present disclosure to provide such a system that utilized a range finding device that emits a signal that is reflected off of a top surface of a liquid in a tank. It is a further feature of the present disclosure, in accordance with one aspect thereof, to provide a system for reporting tank levels over a communication network to designated recipients.

In an embodiment, a system for determining an amount of liquid in a storage tank, the storage tank comprising a sidewall that defines a liquid reservoir, the system comprises: (i) a range finding device having an emitter for emitting signals and a sensor for detecting reflections of the signals off of a liquid in the storage tank, the range finding device further having a microprocessor for determining distance data based upon a time between the emission of the signals and detection of reflections of the signals; (ii) a control device having a microprocessor operable to determine an amount of liquid in the storage tank based upon the distance data provided by the range finding device; wherein the range finding device transmits the distance data to the control device over an electronic communications path.

In an embodiment, the emitter of the range finding device emits light signals. In an embodiment, the light signals are one of visible light and non-visible light. In an embodiment, the light signals comprise laser beams. In an embodiment, the system further comprises a temperature sensor in communication with the liquid, wherein the microprocessor of the control device is further operable to determine a temperature of the liquid based upon temperature data provided by the temperature sensor.

In an embodiment, the control device further comprises a display for displaying an amount of liquid in the tank. In an embodiment, the liquid is milk. In an embodiment, the microprocessor of the control device is operable to generate an electronic report with tank level data. In an embodiment, the microprocessor of the control device is operable to determine the amount of liquid in the storage tank using a look-up table. In an embodiment, the microprocessor of the control device is operable to determine the amount of liquid in the storage tank based upon a geometry of the storage tank.

In an embodiment, a liquid storage system comprises: (I) a storage tank comprising a sidewall that defines a liquid reservoir; (ii) a range finding device coupled to the sidewall of the storage tank, the range finding device having an emitter for emitting signals and a sensor for detecting reflections of the signals off of a liquid in the storage tank, the range finding device further having a microprocessor for determining distance data based upon a time between the emission of the signals and the return of the reflected signals; (iii) a control device having a microprocessor operable to determine an amount of liquid in the storage tank based upon the distance data provided by the range finding device; and (iv) an electronic communications path between the range finding device and the control device; wherein the range finding device transmits that distance data to the control device over the electronic communications path.

In an embodiment, a method for determining an amount of milk in a milk storage tank, said method comprises: (i) filling the milk storage tank with milk; (ii) determining distance data using a range finding device, wherein the distance data is based upon a distance between the range finding device and a top surface of milk in the milk storage tank, wherein the range finding device determines the distance data by calculating a time between emitted signals and reflections of the signals; and (iii) determining an amount of milk in the storage tank based upon the distance data provided by the range finding device.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for determining an amount of liquid in a storage tank, the storage tank comprising a sidewall that defines a liquid reservoir, the system comprising:
a laser range finding device having an emitter for emitting signals and a sensor for detecting reflections of the signals off of a liquid in the storage tank, the laser range finding device further having a microprocessor for determining distance data based upon a time between the emission of the signals and detection of reflections of the signals; and
a control device having a microprocessor operable to determine an amount of liquid in the storage tank based upon the distance data provided by the laser range finding device;
wherein the laser range finding device transmits the distance data to the control device over an electronic communications path.

2. The system of claim 1, wherein the emitter of the laser range finding device emits light signals.

3. The system of claim 2, wherein the light signals are one of visible light and non-visible light.

4. The system of claim 1, wherein the light signals comprise short bursts of laser beams.

5. The system of claim 1, further comprising a temperature sensor in communication with the liquid, wherein the microprocessor of the control device is further operable to determine a temperature of the liquid based upon temperature data provided by the temperature sensor.

6. The system of claim 1, wherein the control device further comprises a display for displaying an amount of liquid in the tank.

7. The system of claim 1, wherein the liquid is milk.

8. The system of claim 1, wherein the microprocessor of the control device is operable to generate an electronic report with tank level data.

9. The system of claim 1, wherein the microprocessor of the control device is operable to determine the amount of liquid in the storage tank using a look-up table.

10. The system of claim 1, wherein the microprocessor of the control device is operable to determine the amount of liquid in the storage tank based upon a geometry of the storage tank.

11. A liquid storage system comprising:
a storage tank comprising a sidewall that defines a liquid reservoir;
a laser range finding device coupled to the sidewall of the storage tank, the laser range finding device having an emitter for emitting signals and a sensor for detecting reflections of the signals off of a liquid in the storage tank, the laser range finding device further having a microprocessor for determining distance data based upon a time between the emission of the signals and the return of the reflected signals;
a control device having a microprocessor operable to determine an amount of liquid in the storage tank based upon the distance data provided by the laser range finding device; and
an electronic communications path between the laser range finding device and the control device;
wherein the laser range finding device transmits that distance data to the control device over the electronic communications path.

12. The system of claim 11, wherein the emitter of the laser range finding device emits light signals.

13. The system of claim 12, wherein the light signals comprise one of visible light and non-visible light.

14. The system of claim 12, wherein the light signals comprise short bursts of laser beams.

15. The system of claim 11, further comprising a temperature sensor in communication with the liquid, wherein the microprocessor of the control device is further operable to determine a temperature of the liquid based upon temperature data provided by the temperature sensor.

16. The system of claim 11, wherein the control device further comprises a display for displaying an amount of liquid in the tank.

17. The system of claim 11, wherein the liquid is milk.

18. The system of claim 11, wherein the microprocessor of the control device is operable to generate an electronic report with tank level data.

19. The system of claim 1, wherein the microprocessor of the control device is operable to determine the amount of liquid in the storage tank using one of a look-up table and a geometry of the storage tank.

20. A method for determining an amount of milk in a milk storage tank, said method comprising:
filling the milk storage tank with milk;
determining a distance between a top surface of the milk and a laser range finding device using signals emitted from the laser range finding device; and
determining an amount of milk in the storage tank based upon the distance determined by the laser range finding device.
